(19) United States
(12) Patent Application Publication
(10) Pub. No.: US 2026/0089289 A1
(43) Pub. Date: Mar. 26, 2026

(54) CAMERAS WITH SCANNING OPTICAL PATH FOLDING ELEMENTS FOR AUTOMOTIVE OR SURVEILLANCE APPLICATIONS

(71) Applicant: Corephotonics Ltd., Tel Aviv (IL)

(72) Inventors: Gal Shabtay, Tel Aviv (IL); Eran Briman, Tel Aviv (IL); Roy Fridman, Tel Aviv (IL); Noy Cohen, Tel Aviv (IL); Ephraim Goldenberg, Tel Aviv (IL); Gil Bachar, Tel Aviv (IL)

(21) Appl. No.: 19/207,416

(22) Filed: May 14, 2025

Related U.S. Application Data
(63) Continuation of application No. 16/978,690, now Pat. No. 12,328,523.
(60) Provisional application No. 62/693,951, filed on Jul. 4, 2018.

(51) Int. Cl. H04N 3/08; B60R 22/48; G06F 18/25; G06V 10/147; G06V 20/52; G06V 20/56; G06V 20/59; G06V 40/10; G06V 40/16; H04N 5/265; H04N 23/58; H04N 23/611; H04N 23/69; H04N 23/698; H04N 23/90

(52) U.S. Cl. CPC H04N 3/08; B60R 22/48; G06F 18/25; G06V 10/147; G06V 20/56; G06V 20/588; G06V 20/597; G06V 40/10; G06V 40/161; G06V 40/172; H04N 5/265; H04N 23/58; H04N 23/611; H04N 23/69; H04N 23/698; H04N 23/90; B60R 2022/4808; G06V 20/52

(57) ABSTRACT

Systems including dual-aperture zoom digital cameras with scanning optical path folding elements (OPFEs) for automotive or surveillance applications and methods for operating and using same. In some embodiments, a dual-aperture zoom digital camera comprises a Wide camera with a Wide field of view FOV_{w}, a Wide sensor and a Wide lens, wherein the Wide camera is operative to output Wide image information, a Tele camera with a Tele field of view FOV_{T} smaller than FOV_{W} and with a Tele sensor, a Tele lens with a Tele lens optical axis and a scanning OPFE, and a processing unit operative to detect an object of interest (OOI) from Wide and/or Tele image information and to direct the Tele camera to move FOV_{T} to acquire Tele image information on the OOI.

### CROSS REFERENCE TO RELATED APPLICATIONS

This application is a continuation of U.S. patent application Ser. No. 16/978,690 filed Sep. 5, 2020 (now allowed), which was a 371 application from international application No. PCT/IB2019/055734 filed Jul. 4, 2019, which claims priority from US Provisional Patent No. 62/693,951 filed Jul. 4, 2018, the content of which application is herein incorporated by reference in its entirety.

### FIELD

Embodiments disclosed herein relate in general to digital cameras and in particular to thin zoom digital cameras.

### BACKGROUND

Host devices having two cameras (also referred to as “dual-camera” or “dual-aperture camera”) are known, see e.g. U.S. Pat. No. 9,185,291. The two cameras have lenses with different focal lengths and have respective image sensors operated simultaneously to capture an image. Even though each lens/sensor combination is aligned to look in the same direction, each will capture an image of the same scene but with a different field of view (FOV). As used herein, “FOV” is defined by the tangent of the angle between a line crossing the lens and parallel to the lens optical axis and a line between the lens and any object that is captured on the respective image corner. For simplicity, “image sensor”is referred to henceforth as “sensor”.

Dual-aperture zoom cameras in which one camera has a “Wide” FOV (FOV_{W}) and the other has a narrow or “Tele” FOV (FOV_{T}) are also known, see e.g. U.S. Pat. No. 9,185,291. The cameras are referred to respectively as Wide and Tele cameras that include respective Wide and Tele sensors. These sensors provide respectively separate Wide and Tele images. The Wide image captures FOV_{W} and has a lower spatial resolution than the spatial resolution of the Tele image that captures FOV_{T}. The images may be merged (fused) together to form a composite image. In the composite image, the central portion is formed by combining the relatively higher spatial resolution image taken by the lens/sensor combination with the longer focal length, and the peripheral portion is formed by a peripheral portion of the relatively lower spatial resolution image taken by the lens/sensor combination with the shorter focal length. The user selects a desired amount of zoom and the composite image is used to interpolate values from the chosen amount of zoom to provide a respective zoom image. Hereinafter, the use of “resolution” in this description refers to image spatial resolution, which is indicative to the resolving power of a camera as determined by the lens focal length, its aperture diameter and the sensor pixel size.

Dual-aperture cameras in which one image (normally the Tele image) is obtained through a folded optical path are known, see e.g. co-invented and co-owned U.S. patent application Ser. No. 14/455,906, which teaches zoom digital cameras comprising an “upright” (with a direct optical axis to an object or scene) Wide camera and a “folded” Tele camera, see also FIG. 2B below. The folded camera has an optical axis substantially perpendicular (orthogonal) to an optical axis of the upright camera. The folded Tele camera may be auto-focused and optically stabilized by moving either its lens or by tilting an optical path folding (reflecting) element (“OPFE”), e.g. a prism or mirror inserted in an optical path between its lens and a respective sensor. For simplicity, the OPFE is referred to hereinafter generically as “prism”, with the understanding that the term may refer to any other optical path folding (reflecting) element that can perform the function of folding an optical path as described herein, for example a mirror.

For example, PCT patent application PCT/IB2016/056060 titled “Dual-aperture zoom digital camera user interface” discloses a user interface for operating a dual-aperture digital camera included in host device, the dual-aperture digital camera including a Wide camera and a Tele camera, the user interface comprising a screen configured to display at least one icon and an image of a scene acquired with at least one of the Tele and Wide cameras, a visible frame defining FOV_{T} superposed on a Wide image defined by FOV_{W}, and means to switch the screen from displaying the Wide image to displaying the Tele image. The user interface further comprises means to switch the screen from displaying the Tele image to displaying the Wide image. The user interface may further comprise means to acquire the Tele image, means to store and display the acquired Tele image, means to acquire simultaneously the Wide image and the Tele image, means to store and display separately the Wide and Tele images, a focus indicator for the Tele image and a focus indicator for the Wide image.

Object recognition is known and describes the task of finding and identifying objects in an image or video sequence. Many approaches have been implemented for accomplishing this task in computer vision systems. Such approaches may rely on appearance-based methods by using example images under varying conditions and large model-bases, and/or on feature-based methods that search to find feasible matches between object features and image features, e.g., by using surface patches, corners and edges detection and matching. Recognized objects may be tracked in preview or video feeds using an algorithm for analyzing sequential frames and outputting the movement of targets between the frames.

The problem of motion-based object tracking may be divided into two parts:
(1) detecting moving objects in each frame. This may be done either by incorporating an object recognition algorithm for recognizing and tracking specific objects (e.g. a human face) or, for example, by detecting any moving object in a scene. The latter may incorporate a background subtraction algorithm based on Gaussian mixture models with morphological operations applied to the resulting foreground mask to eliminate noise. Blob analysis can later detect groups of connected pixels, which are likely to correspond to moving objects; and
(2) associating the detections corresponding to the same object over time, e.g., using motion estimation filters such as the Kalman filter.

In automotive or surveillance applications involving cameras it would be advantageous to have the ability to inspect a certain region of interest with high resolution. If addressed by a single camera, the required spatial resolution will force the single camera to have a sensor with a very large number of pixels.

There is therefore a need to identify a specific region of interest in an image with large field of view and steer a camera with a narrow field of view to that location.

### SUMMARY

In various embodiments there are provided systems comprising dual-aperture zoom digital cameras with scanning OPFEs for automotive or surveillance applications and methods for operating and using same.

In exemplary embodiments, there are provided systems comprising: a Wide camera with a Wide field of view FOV_{W} and comprising a Wide sensor and a Wide lens, wherein the Wide camera is operative to output Wide image information; a Tele camera with a Tele field of view FOV_{T} smaller than FOV_{W} and comprising a Tele sensor, a Tele lens with a Tele lens optical axis and a scanning OPFE; and a processing unit operative to detect an object of interest (OOI) from Wide and/or Tele image information and to direct the Tele camera to move FOV_{T} to acquire Tele image information on the OOI.

In an exemplary embodiment, the system is installed in a vehicle and the processing unit is further operative to calculate a required measure-of-action or response needed from the vehicle.

In an exemplary embodiment, a system further comprises an actuator to tilt the OPFE to move the FOV_{T}.

In an exemplary embodiment, the processing unit is operative to direct the Tele camera to move FOV_{T} to substantially a center of the FOV_{W}.

In an exemplary embodiment, the processing unit is operative to direct the Tele camera to move FOV_{T} to a center of the OOI.

In an exemplary embodiment, the processing unit is operative to receive steering information from a steering wheel of the vehicle and to direct the Tele camera to move FOV_{T} also based on the steering information.

In an exemplary embodiment, the processing unit is operative to receive steering information from a steering wheel of the vehicle and the actuator tilts the OPFE to move FOV_{T} also based on the steering information.

In an exemplary embodiment, FOV_{W} covers a road in front of the vehicle, the OOI is a road curve and the processing unit is operative to move FOV_{T} to follow the road curve,

In an exemplary embodiment, the vehicle has a vehicle cabin, the OOI is located inside the vehicle cabin and the OPFE may be tilted to provide an extended Tele camera FOV (FOV_{E}) greater than FOV_{T}.

In an exemplary embodiment, the OOI is a driver of the vehicle and the required measure-of-action or response is based on a gaze of the driver.

In an exemplary embodiment, the OOI is a child and the required measure-of-action or response is a warning that the child does not wear a seat belt.

In an exemplary embodiment, the required measure-of-action or response includes a measure-of-action or response selected form the group consisting of changing speed and/or course of the vehicle, operating an internal alarm to a driver of the vehicle, operating an external alarm, sending data information to, or calling Internet/cloud based service/police/road assistance services, and a combination thereof.

In an exemplary embodiment, the OOI is a human face.

In an exemplary embodiment, the processing unit is operative to instruct the Tele camera to move to a specific location of the human face for face recognition.

In an exemplary embodiment, the processing unit is operative to instruct the Tele camera to move FOV_{T} to scan parts of FOV_{W} in two directions.

In an exemplary embodiment, the scan is performed by the scanning OPFE with a tilting and settling time of the OPFE of between 5-50 msec.

In an exemplary embodiment, the processing unit is operative to detect the OOI from Wide and/or Tele image information and to direct the Tele camera to move FOV_{T} to acquire information on the OOI in automatic tracking mode.

In an exemplary embodiment, the Wide and Tele image information may be fused together to form a composite image or a composite video stream.

In an exemplary embodiment, each composite image has the same field of view.

In an exemplary embodiment, a composite image is formed by stitching a plurality of Tele images.

### BRIEF DESCRIPTION OF THE DRAWINGS

Non-limiting examples of embodiments disclosed herein are described below with reference to figures attached hereto that are listed following this paragraph. Identical structures, elements or parts that appear in more than one figure are generally labeled with a same numeral in all the figures in which they appear. The drawings and descriptions are meant to illuminate and clarify embodiments disclosed herein, and should not be considered limiting in any way.

FIG. 1A shows an embodiment of a system disclosed herein;

FIG. 1B shows an example of elements of a dual-camera in a perspective view;

FIG. 2 shows schematically a use case of the system of FIG. 1A;

FIG. 3 shows a flow chart of a method in the use case of FIG. 2;

FIG. 4A shows another embodiment of a system disclosed herein;

FIG. 4B shows yet another embodiment of a system disclosed herein;

FIG. 5 shows schematically a use case of the systems of FIG. 4A or 4B;

FIG. 6A shows schematically a method of use of the systems in FIG. 4A or 4B;

FIG. 6B shows schematically another method of use of the systems in FIG. 4A or 4B;

FIG. 6C shows schematically yet another method of use of the systems in FIG. 4A or 4B;

FIG. 7A shows yet another embodiment of a system disclosed herein;

FIG. 7B shows yet another embodiment of a system disclosed herein;

FIG. 8 shows a vehicle cabin section and use case of a system in FIGS. 7A and 7B;

FIG. 9A shows schematically a method of use of the systems in FIG. 7A;

FIG. 9B shows schematically another method of use of the systems in FIG. 7B;

FIG. 10A shows yet another embodiment of a system disclosed herein;

FIG. 10B shows the resolution of an image obtained with known digital zoom;

FIG. 10C shows the resolution of an image obtained with “optical” zoom using the system of FIG. 10A.

### DETAILED DESCRIPTION

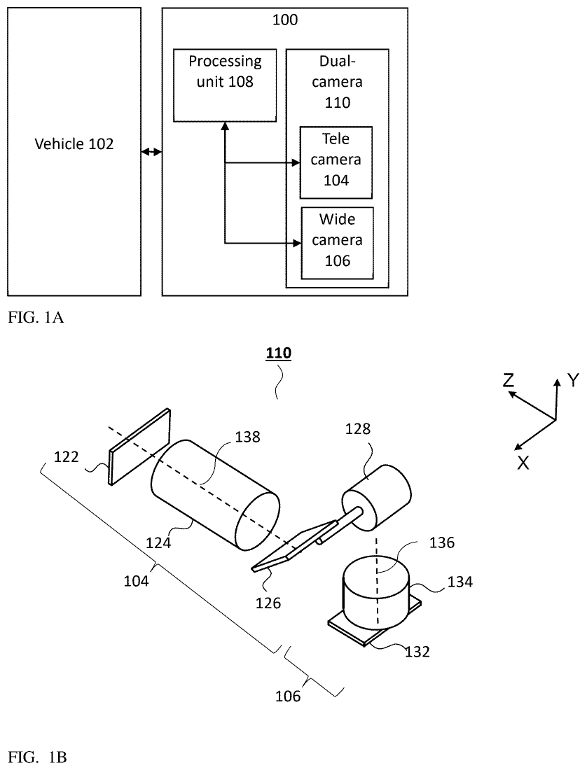

FIG. 1A shows an embodiment of a system disclosed herein and numbered 100. System may be installed in, or attached to a vehicle 102. System 100 includes a Tele camera 104, a Wide camera 106 and a processing unit (“processor”) 108. The vehicle may be for example a car, a bus, a truck, a motorcycle, a coach or any type of know vehicle. Processing unit 108 may be a CPU, GPU, ASIC, FPGA, or any other processor capable of graphic analysis. When used in conjunction with a vehicle, a system like system 100 may also be referred to as “advanced driver assistant system” or ADAS.

The combination of Tele camera 104 and Wide camera 106 may be referred as “dual-camera” and is numbered 110. FIG. 1B shows an example of elements of a dual-camera 110 in a perspective view. Wide camera 106 comprises a Wide sensor 132 and a Wide lens 134 with a Wide lens optical axis 136. Wide sensor 132 is characterized by a Wide sensor active area size and a Wide sensor pixel size. Wide lens 134 is characterized by a Wide effective focal length (EFL) marked EFL_{W}. Optionally, in an embodiment, Wide lens 134 may have a fixed (constant) EFL_{W}. Optionally, the Wide lens may be fixed at a constant distance from Wide sensor 132 (fixed focus). Optionally, Wide lens 134 may be coupled to a focusing mechanism (e.g. an autofocus (AF) mechanism) that can change the distance of Wide lens 134 from Wide sensor 132, thereby providing a non-fixed (variable) focus). The combination of Wide sensor area and EFL_{W} determines the Wide FOV (FOV_{W}). According to some examples, FOV_{W} may be 50-100 degrees in the horizontal vehicle-facing direction.

Tele camera 104 comprises a Tele sensor 122 and a Tele lens 124 with a Tele lens optical axis 138. Tele sensor 122 is characterized by a Tele sensor active area size and a Tele sensor pixel size. Tele lens 124 is characterized by a Tele EFL, marked EFT_{T}. Optionally, in an embodiment, Tele lens 124 may have fixed (constant) EFL. In some embodiments, the Tele lens may be fixed at a constant distance from Tele sensor 122 (fixed focus). Optionally, the Tele lens may be coupled to a focusing mechanism (e.g. an AF mechanism) that can change the distance of Tele lens 124 from Tele sensor 122 (non-fixed focus). The combination of Tele sensor area and Tele lens EFL_{T} determines the Tele FOV (FOV_{T}). According to some examples, FOV_{T} may be between 10-30 degrees in the horizontal vehicle-facing direction. Thus, FOV_{T} is smaller (narrower) than FOV_{W}.

Tele camera 104 further comprises an OPFE 126, e.g. a mirror or a prism. OPFE 126 has a reflection surface tilted by 45 degrees at a rest point from the Tele lens optical axis 138. Tele camera 104 further comprises an actuator (motor) 128. Actuator 128 may tilt the reflecting surface of OPFE 126 by up to t a degrees from the rest point (where exemplary a may be up to 10, 20, 40 or 70 degrees). That is, actuator 128 may tilt or scan the OPFE and with it FOV_{T}. Actuator 128 may be for example a stepper motor, or a voice coil motor (VCM) as described for example in co-owned patent application PCT/IB2017/057706.

In some examples, Wide camera 106 and Tele camera 104 face a vehicle front side and share at least some of their respective FOVs. Typically, FOV_{W} is directed away from the vehicle toward the front direction (driving direction) and is substantially symmetrical vs. the two sides of the vehicle. In one operational mode, the Tele camera is operational to scan the Tele FOV (FOV_{T}) inside the Wide FOV (FOV_{W}) using actuator 128. In some examples, the scanning of FOV_{T} is for bringing the Tele camera to view more closely a detected potential object-of-interest (OOI), detected previously from Wide and/or Tele images, see in more detail below.

FIG. 2 shows schematically a use case of the system 100 of FIG. 1A. A dual-camera 110 is installed in a front part of a vehicle 102. For example, a triangle 204 represents FOV_{W} in a horizontal plane, i.e. as a horizontal FOV_{W} or “HFVO_{W}”. In FOV_{W}, an “observation distance” 206 is defined as the maximal distance that allows system 100 using an image from the Wide camera to detect a potential OOI. “OOI” may be for example a hazard, another vehicle, a hole or obstruction on a road, a pedestrian, a road curve, a road sign, etc. An “identification distance” 208 is defined as the minimal distance that allows system 100 using an image from the Wide camera to identify all the required information for making a decision, as known in the art. According to one example, the OOI may be a road sign observable but not readable in the observation distance. According to an example, an OOI may be observed in the observation distance, but identification or distinction between it being a road sign or a pedestrian is made only within the identification distance. In other words, if an OOI is located before (closer to the Wide camera than) the observation distance 206 but further than the identification distance 208, then system 100 may use an image from the Wide camera to calculate that the OOI is located in FOV_{W} , but not to fully calculate required measures-of-action or response needed (see next).

According to some examples, measures-of-action or responses of system 100 may include one or more or a combination of the following: changing vehicle 102 speed and/or course, operating an internal alarm to the vehicle driver, operating an external alarm, sending data information to, or calling Internet/cloud based service/police/road assistance services, etc. For example, a triangle 210 represents FOV_{T} in a horizontal plane, i.e. as a horizontal FVO_{T} (HFVO_{T}). According to one example, HFOV_{W} may be in the range of 70-180 degrees and HFOV_{T} may be in the range of 15-45 degrees. According to another example, HFOV_{W} may be in the range of 140-180 degrees and HFOV_{T} may be in the range of 15-70 degrees. Thus, the output images of the Tele camera may have higher resolution than the output images of the Wide camera. For example, the output image of the Tele camera may have 3 to 20 times more resolution than the output image of the Wide camera, and consequently identification distance 212 of the Tele camera may be 3 to 20 times further away than identification distance 208 of the Tele camera.

In an example shown in (a) of FIG. 2, vehicle 102 approaches OOI 202. OOI 202 is located between observation distance 206 and identification distance 208. While OOI 202 is observable by the Wide camera, it may not identifiable (namely the Wide camera captures OOI 202 with too low a resolution to identify, classify or handle, relative to the required by system 100). As shown in FIG. 2(b), POV_{T} is then scanned to face OOI 202 such that the Tele camera may capture OOI 202 with more detail (e.g. “identify”it).

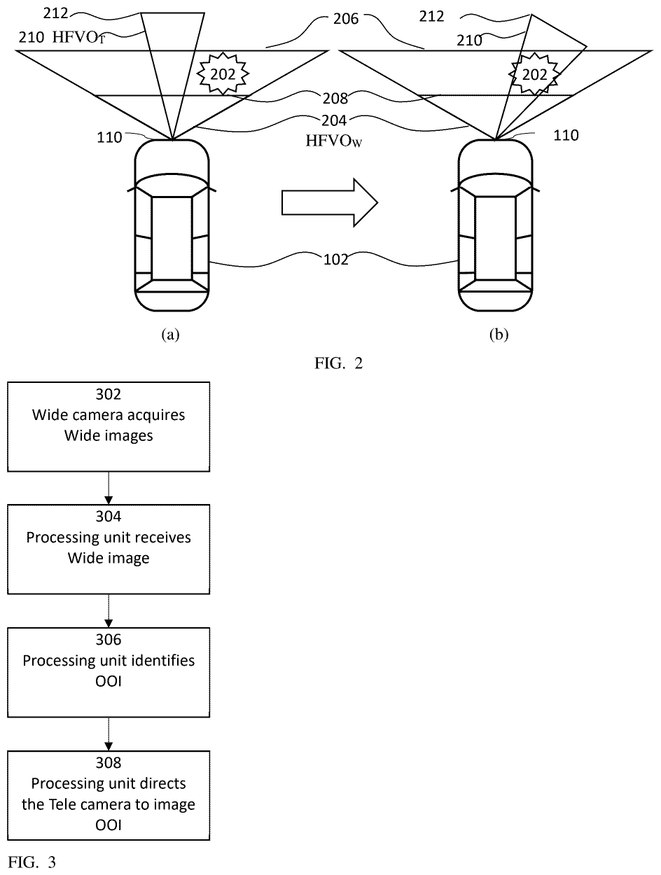

FIG. 3 shows a detailed flow chart of a method of operation of system 100 as in the example of FIG. 2:
Step 302: Exemplarily, the Wide camera (e.g. 106) acquires Wide images. In some alternative embodiments, images may also or optionally be acquired by the Tele camera.
Step 304: Exemplarily, the Wide camera sends Wide images acquired in step 302 to a processing unit (e.g. 108) for analysis. In some alternative embodiments, Tele images acquired in step 302 may also or optionally be to sent to the processing unit for analysis.
Step 306: The processing unit detects the existence of OOI 202 in front of vehicle 102, but requires more details to address or decide on a course of action.
Step 308: The processing unit directs the Tele camera (e.g. 104) to have FOV_{T} face OOI 202 (i.e. by scanning the Tele camera), thereby acquiring and receiving images of OOI 202 with higher quality and/or higher resolution. The processing unit may then have more information on the OOI in order to fully calculate required measures-of-action or response needed.

In some examples, the Tele camera may be a camera equipped with a motor to drive the entire camera. In some examples, the Tele camera may be a folded camera as described in co-owned patent application PCT/IB2016/057366, in which the OPFE is operational to change (i.e. scan) a Tele camera point of view (POV). In some examples, the Tele camera may scan in one dimension (1D) only (i.e. along a line). In some examples, the Tele camera may scan in two dimensions (2D), namely scan an area. In some examples, the motor for scanning may be a VCM, a shape memory alloy (SMA) motor, a piezoelectric motor, a stepper motor or a DC motor. In some examples, the Tele camera and/or the Wide camera may be integrated with optical image stabilization (OIS) to compensate on vehicle vibrations.

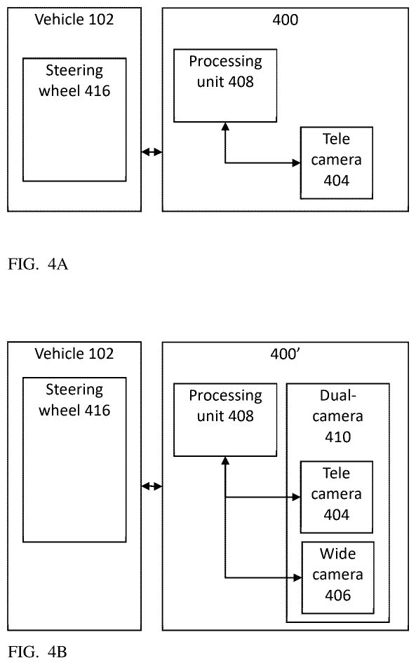

FIG. 4A shows an embodiment of a system numbered 400 installed in, or attached to a vehicle 402. Optionally, vehicle 402 may have a steering wheel 416. In some vehicles, handlebars (not shown) may replace a steering wheel, with the following description being relevant to both. In contrast with system 100, system 400 comprises only a Tele camera 404 (similar to Tele camera 104) and a processing unit 408 (similar to processing unit 108).

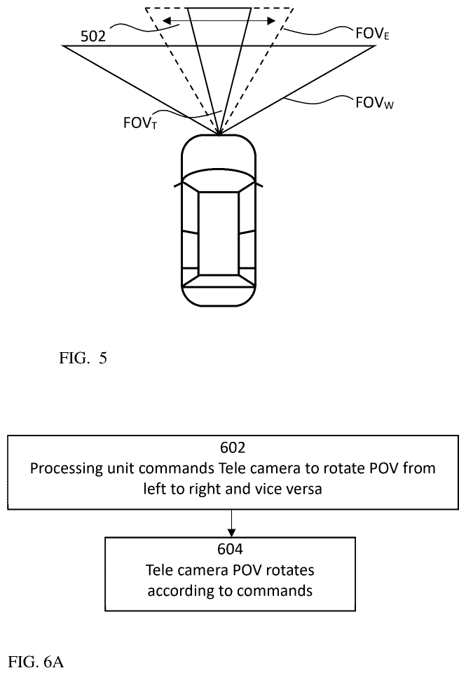

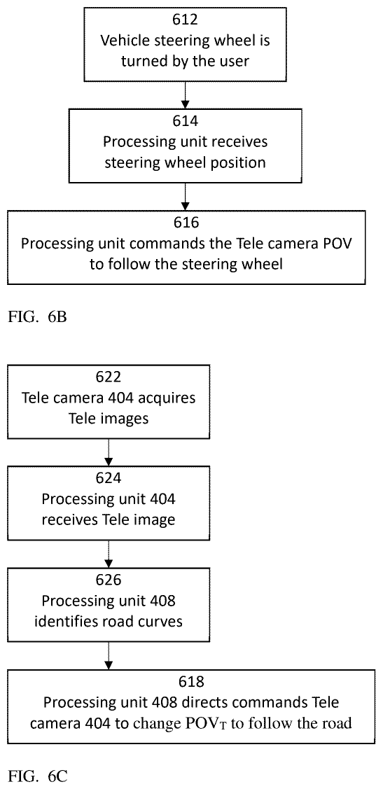

FIG. 4B shows an embodiment of another system numbered 400′, similar to system 100 i.e. comprising a Wide camera 406 in addition to Tele camera 404. The description below refers to systems 400 and 400′. The Tele camera faces the vehicle front side. As seen in FIG. 5, in system 400, Tele camera 404 is operational to change angle/direction of POV_{T} as marked by an arrow 502, thereby achieving an “effective” FOV marked FOV_{E}, which is larger than FOV_{T}. According to one optional use case of system 400 (FIG. 6A), a processing unit constantly commands the Tele camera to continually change the POV direction or angle from left to right and vice-versa (602), and the Tele camera rotates according to the commands received (604). In a second optional use case of system 400 (FIG. 6B), the processing unit follows the steering wheel or handle bars: when the user turns the steering wheel/handle bar to the left (612), the Tele camera POV (POV_{T}) moves to the left, and when the user turns the steering wheel/handle bar to the right, POV_{T} moves to the right. According to a third optional use case of system 400 (FIG. 6C), the processing unit may use image recognition algorithm to identify road curves and change FOV_{T} to follow the road.

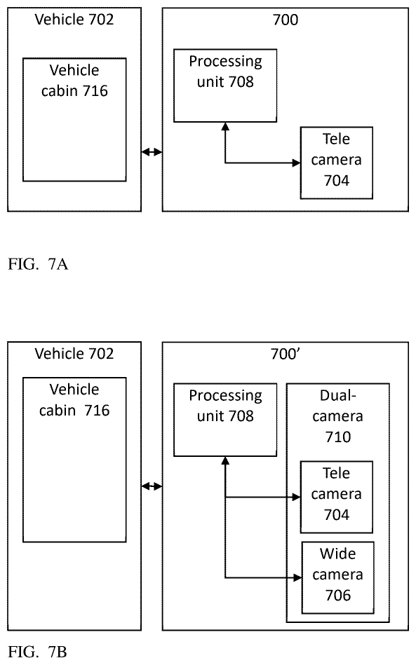

FIG. 7A shows another shows an embodiment of another system numbered 700 (similar e.g. to system 400) that may be installed in, or attached to a vehicle 702. Vehicle 702 comprises a vehicle cabin 716.

FIG. 7B shows an embodiment of yet another system numbered 700′, similar to system 100 and including a Wide camera 706 (like Wide camera 106) in addition to Tele camera 704. Wide camera 706 may also be installed in vehicle cabin 716 to face OOI 802.

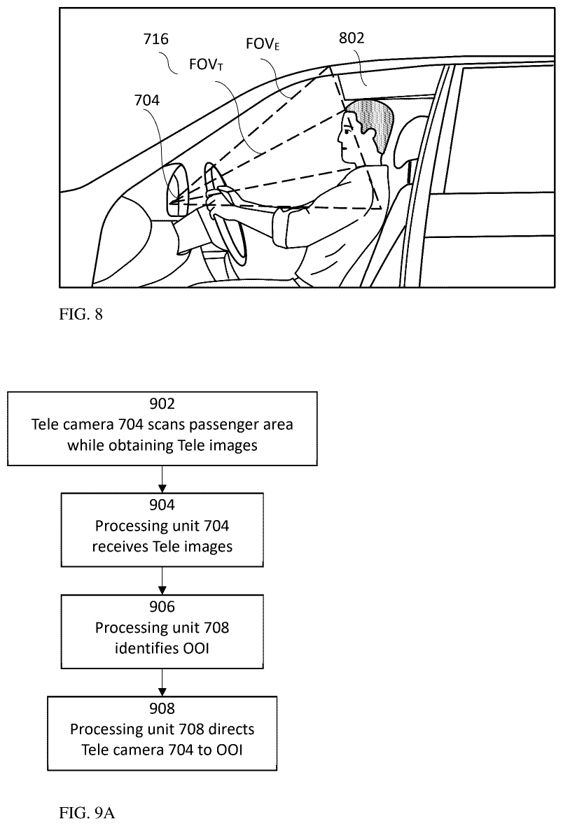

FIG. 8 shows a vehicle cabin section and use case of a system in FIGS. 7A and 7B. Wide camera 706 is not shown. Tele camera 704 with FOV_{T} faces the interior of vehicle cabin 716 and an OOI 802, for example a passenger. Tele camera 704 may be scanned to allow the effective FOV (FOV_{E}) larger than FOV_{T}.

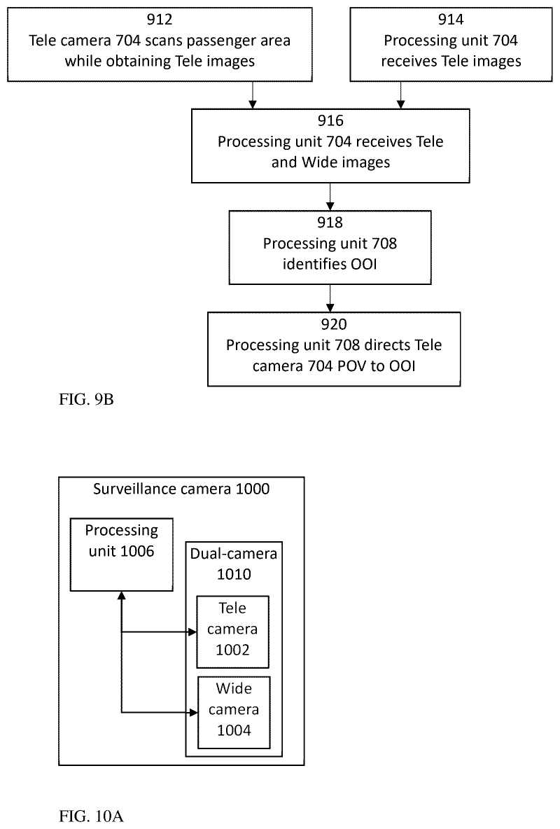

FIG. 9A shows in a flow chart main steps of a method of use of system 700. Tele camera 704 is operational to change angle / direction and scan vehicle cabin 716. Processing unit 708 is operational to identify an OOI 802 (e.g. passenger body, face, eyes, etc.). Processing unit 708 is further operational to direct Tele camera 704 to face OOI 802. The data obtained by the Tele camera is used for identifying hazards (e.g. driver not looking at the road, driver falling asleep, passengers without seatbelts, a child without a child seat, etc.). FIG. 9B shows in a flow chart main steps of a method of use of system 700′. The processing unit uses data from both Wide and Tele cameras to direct the Tele camera to OOI 802.

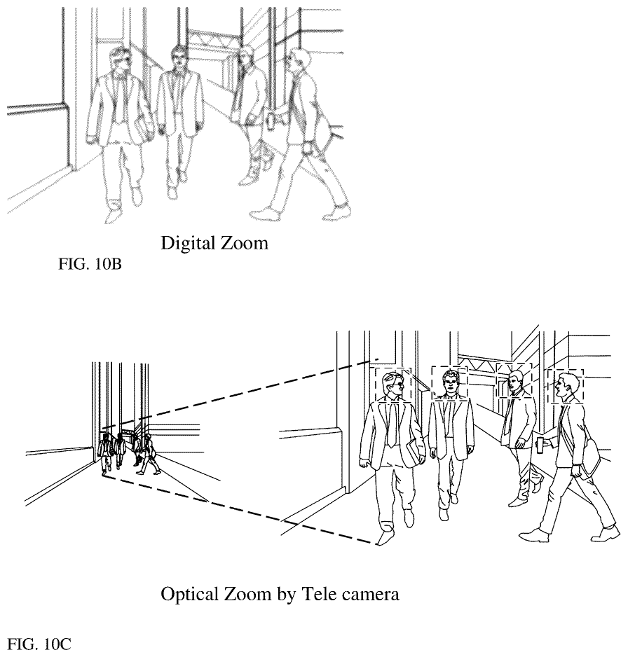

FIG. 10A shows an embodiment of yet another system disclosed herein and numbered 1000. Surveillance camera 1000 comprises a Tele camera 1002, a Wide camera 1004 and a processing unit 1006 and may be used for surveillance, thus being also named “surveillance camera”. Tele camera 1002 and Wide camera 1004 are part of a dual-camera 1010. These components may be similar to or even identical with Wide and Tele cameras and processors described in embodiments above. Surveillance camera 1000 and processing unit 1006 may include software and algorithms to detect OOIs (for example human faces) in FOV_{W} and to steer the Tele camera in X and Y directions in Wide images to these OOIs to enhance the image or video quality of these objects and to enable their analysis (e.g. for face recognition in the case where the object is a face).

In an embodiment, processing unit 1006 may instruct Tele camera 1002 to continuously scan parts of FOV_{W}. In an embodiment, processing unit 1006 may instruct Tele camera 1002 to move to a specific location (as in FIG. 9). The tilting and settling time of the prism may occur in 5-50 msec. Further, Tele camera 1002 may switch from pointing from one region of interest (ROI) to another every 1 sec, or at a faster or slower pace. FIG. 10B shows an example of an imaged scene acquired by Wide camera 1004 and then digitally zoomed, and FIG. 10C shows an example of an imaged scene acquired by Wide camera 1004 (left side) and then by a directed Tele camera 1002 to optically zoom on the ROI (right side). The zoomed image in FIG. 10C shows significant resolution gain over the digitally zoomed image in FIG. 10B, allowing for example facial recognition of people in the ROI.

Wide and Tele images and/or video streams may be recorded during automatic tracking mode and may be fused together to form a composite image or a composite video stream, as known in the art. This fusion may be applied on a camera hosting device (e.g. a mobile electronic device of any type that includes a a system or camera disclosed herein). Alternatively, Wide and Tele images or video streams may be uploaded to the cloud for applying this fusion operation. Each composite image may also have the same FOV, by scanning with the Tele camera, stitching a plurality of Tele images to provide a “stitched” Tele image, then fusing the stitched Tele image with a Wide image. This is advantageous in that the Wide image captures the entire scene simultaneously, while the Tele images to be stitched together are consecutive, so one can overcome motion or occlusions in the scene if required. The stitching of the Tele images and/or the fusion of the stitched Tele image with the Wide image may also be performed in a cloud.

While this disclosure has been described in terms of certain embodiments and generally associated methods, alterations and permutations of the embodiments and methods will be apparent to those skilled in the art. The disclosure is to be understood as not limited by the specific embodiments described herein, but only by the scope of the appended claims.

What is claimed is:

1. A system, comprising:
one or more cameras, wherein the one or more cameras are configured to provide a first video stream of first images and a second video stream of second images, wherein the first images have first image information and a first field of view (FOV1) and the second images have second image information and a second field of view (FOV2) smaller than FOV1, and wherein FOV2 is configured to scan within FOV1; and
a processing unit configured to detect an object of interest (OOI) from the first image information and, when the OOI is further than a distance that allows identification of the OOI in the first image information, to direct FOV2 to scan within FOV1 to acquire second image information on the OOI.

2. The system of claim 1, wherein FOV1 has a range of 50-100 degrees.

3. The system of claim 1, wherein FOV2 has a range of 10-30 degrees.

4. The system of claim 1, wherein the first images have a first spatial resolution, and wherein the second images have a second spatial resolution higher than the first resolution.

5. The system of claim 1, wherein the processing unit is configured to direct FOV2 to scan to substantially a center of the FOV1.

6. The system of claim 1, wherein the processing unit is configured to direct FOV2 to scan to substantially a center of the OOI.

7. The system of claim 1, wherein the processing unit is configured to direct FOV2 to scan to a specific location of the OOI.

8. The system of claim 1, wherein the OOI is a face and the second image information is used for facial recognition.

9. The system of claim 1, wherein the processing unit is configured to direct FOV2 to scan parts of FOV1 in two directions.

10. The system of claim 1, wherein the processing unit is configured to direct FOV2 to scan within FOV1 to acquire second image information on the OOI in an automatic tracking mode.

11. The system of claim 1, wherein the system is included in a mobile electronic device.

12. The system of claim 1, wherein the processing unit is installed in a vehicle and wherein the processing unit is configured to calculate a required measure-of-action or response needed from the vehicle.

13. The system of claim 12, wherein the OOI is a face of a driver of the vehicle and wherein the required measure-of-action or response is based on a gaze of the driver.

14. The system of claim 12, wherein the OOI is a face of a child and wherein the required measure-of-action or response is a warning that the child is not wearing a seatbelt.

15. The system of claim 12, wherein the required measure-of-action or response is selected from the group consisting of changing speed and/or course of the vehicle, operating an internal alarm to a driver of the vehicle, operating an external alarm, sending data information to, or calling Internet/cloud based service/police/road assistance services, and a combination thereof.

16. The system of claim 12, wherein the processing unit is configured to receive steering information from a steering wheel of the vehicle and to direct FOV2 to scan based also on the steering information.

17. The system of claim 12, wherein FOV1 covers a road in front of the vehicle, wherein the OOI is a road curve, and wherein the processing unit is configured to direct FOV2 to follow the road curve.

18. The system of claim 1, wherein the first and second image information may be fused together to form a composite image or a composite video stream.

19. The system of claim 18, wherein each composite image has the same field of view.

20. A system, comprising:
one or more cameras configured to provide a first video stream of first images and a second video stream of second images; and
a processing unit configured to record the first video stream and the second video stream during an automatic tracking mode and to fuse together the recorded first video stream and the recorded second video stream to form a composite image or a composite video stream.
